(19) United States
(12) Patent Application Publication
(10) Pub. No.: US 2008/0005132 A1
(43) Pub. Date: Jan. 3, 2008

(54) METHOD AND SYSTEM FOR DESCRIBING AND STORING BURSTING METADATA IN A CONTENT MANAGEMENT SYSTEM

(76) Inventors: David G. Herbeck, Rochester, MN (US); John E. Petri, Lewiston, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/427,870

(22) Filed: Jun. 30, 2006

(51) Int. Cl. G06F 17/00

(52) U.S. Cl. 707/100

(57) ABSTRACT

Embodiments of the invention provide a method, system, and article of manufacture for describing and storing bursting metadata used by a content management system (CMS). When a user interacts with a client application to check-out a data object, the CMS retrieves the bursting rules and bursting metadata associated with the object being checked out, assembles the burst components into the object requested by the user, and transmits this information to the client application. Conversely, when an object is checked back in, the CMS receives the object and uses the bursting rules to “burst” components of the data object being into a number of reusable components.

### BACKGROUND OF THE INVENTION

1. Field of the Invention

Embodiments of the invention are generally related to storing information in a content management system. More specifically, embodiments of the invention are generally related to a method and system for describing and storing bursting metadata associated with a burst data object managed by the content management system.

2. Description of the Related Art

Content management systems (CMS) allow multiple users to share information. Generally, a CMS system allows users to create, modify, archive, search, and remove data objects from an organized repository. The data objects managed by CMS may include documents, spreadsheets, database records, digital images and digital video sequences. A CMS typically includes tools for document publishing, format management, revision control, indexing, search and retrieval.

One useful feature employed by some CMS systems is referred to as document “bursting” (sometimes referred to as “chunking”). Generally, bursting is the process of breaking apart a data object, often marked up using the XML markup language, into smaller chunks, where each chunk can be managed as its own object in the CMS. That is, each object can have its own access control rules, revision or version information, lifecycles, etc. When the user checks-out a burst data object, the CMS application assembles the various chunks automatically so that the XML document appears to be a single unit again. However, the burst data object typically requires special metadata to be embedded indicating to a client application (e.g., a word processor application, spreadsheet application or other client application) which elements are their own objects, and whether those objects have read-only or write access for the user's current editing session. In order to describe the portions of a burst document, current CMS systems typically require that the document's DTD or schema be changed to allow for extra attributes or elements to be inserted by the application. However, this approach is far from ideal as the DTDs and XML schemas associated with the data objects are commonly owned by the customer and changing them is not always possible.

Moreover, even when it is possible to change a customer's schema (which current art requires to enable bursting), it often has to be performed up-front with minimal changes so that the customer's DTD's and/or schemas are minimally affected. Alternatively, users can create a replica of the customer's schema that is used exclusively for describing bursting data; but the approach of managing two closely related schemas that are differentiated by context introduces problematic maintenance issues; namely, it becomes very difficult to simultaneously maintain both the “official version” and the “side version” created to allow document bursting by the CMS.

Accordingly there remains a need for techniques for describing and strong bursting metadata associated with a burst data object managed by a content management system.

### SUMMARY OF THE INVENTION

Embodiments of the invention provide an effective solution to describing and storing bursting metadata associated with a burst data object stored by a content management system (CMS). One embodiment of the invention includes a method of managing content in a content management system. The method generally includes identifying a set of bursting rules associated with a specified type of data object, wherein the bursting rules specify portions of the data object that may be stored independently by the CMS and receiving a data object of the specified type. The method generally further includes parsing the received data object to identify portions of the data object that may be stored independently by the CMS, based on the bursting rules, bursting the parsed data object into a collection of burst data objects, and generating a bursting metadata file describing attributes of the data object.

Another embodiment of the invention includes a computer-readable medium containing a program which, when executed, performs an operation for managing content in a CMS. The operation generally includes identifying a set of bursting rules associated with a specified type of data object, wherein the bursting rules specify portions of the data object that may be stored independently by the CMS and receiving a data object of the specified type. The operations generally further include parsing the received data object to identify portions of the data object that may be stored independently by the CMS, based on the bursting rules, bursting the parsed data object into a collection of burst data objects, and generating a bursting metadata file describing attributes of the data object.

Still another embodiment of the invention provides a system that includes a processor and a memory containing a CMS. The CMS may generally be configured to identify a set of bursting rules associated with a specified type of data object, wherein the bursting rules specify portions of the data object that may be stored independently by the CMS and to receive a data object of the specified type. The CMS may generally be further configured to parse the received data object to identify portions of the data object that may be stored independently by the CMS, based on the bursting rules, and burst the parsed data object into a collection of burst data objects, and to generate a bursting metadata file describing attributes of the data object.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

Note, however, that the appended drawings illustrate only typical embodiments of this invention and are therefore not to be considered limiting of its scope, for the invention may admit to other equally effective embodiments.

FIG. 1 is a block diagram illustrating a computing environment and content management system, according to one embodiment of the invention.

FIG. 2 is a block diagram illustrating a client application used to check-in and -out data objects from a content management system, according to one embodiment of the invention.

FIG. 3 illustrates an exemplary data object that may be burst into multiple reusable components by a content management system, according to one embodiment of the invention.

FIG. 4 illustrates a method for creating a new data object that may include multiple reusable components, according to one embodiment of the invention.

FIG. 5 illustrates a method for checking out a burst data object from a content management system, according to one embodiment of the invention.

FIG. 6 illustrates a method for checking in and bursting a data object managed by a content management system, according to one embodiment of the invention.

### DETAILED DESCRIPTION OF THE PREFERRED EMBODIMENTS

Embodiments of the invention provide a method, system, and article of manufacture for describing and storing bursting metadata used by a content management system (CMS). In one embodiment, the bursting metadata is used by the CMS to manage a collection of reusable data objects. For example, a section of text from a word processing document may be included in multiple files. When a document that includes the section of text is checked into the CMS, the CMS may burst the document into multiple portions and independently store each portion. Rather than store bursting metadata as part of a particular data object, bursting metadata may be maintained by a separate data file associated with a given data object. Thus, each burst part of the data object may then be managed separately by the CMS. The bursting metadata for a given data object may specify access control rules or attributes, or other properties associated with that data object.

In one embodiment, when a user interacts with a client application to check out a data object, the CMS retrieves the bursting rules and bursting metadata associated with the object being checked out, assembles the burst components into the object requested by the user, and transmits this information to the client application. Conversely, when an object is checked back in, the CMS receives the object and uses the bursting rules to “burst” components of the data object being into a number of reusable components.

For example, consider a user authoring a product manual that provides a set of written instructions for a consumer product. When checked out, a user may edit the product manual as a single document. At the same time, certain components of the product manual may be standardized (e.g., a table of contents, or legal disclaimers, or copyright legends), these sections may be stored by the CMS as individual burst objects that may be recombined into a single whole when the product manual is checked out. Further, bursting metadata associated with the product manual may specify different access control rules (i.e., read and write permissions) to apply to different sections of the manual. For example, a user writing substantive portions of the product manual may be prevented from modifying the standardized legal disclaimers, or from altering which sections are included the product manual.

As another example, consider a manufacturing company using a computer aided design application to design a series of related products. The components of a product may be represented using a collection of burst objects. When a user checks out a CAD drawing representing a particular product, all of the components included in that product may be combined and transmitted to the user as a data object. Depending on the user's authority, the user may be able to modify the design of some aspects of the product, but not others. When the user checks the product drawings back into the CMS, the drawings may be “burst” back into the individual components, including any components of the drawing marked by the user as being eligible to be shared across multiple products.

Additionally, embodiments of the invention are described herein relative to the widely used XML markup language. As is known. XML may be used to describe virtually any type of data. For example, XML grammars have been used to describe word processing documents, spreadsheets, database records, digital images and digital video, to name but a few. Further, the known Xpath query language and Xinclude document inclusion mechanism may be used by the CMS as a mechanism for referencing “burst” elements in an XML document and for generating an object from multiple, burst components. However, the invention is not limited to the XML markup language; rather, embodiments of the invention may be adapted to other markup languages or other data object formats or representations, whether now known or later developed.

As used herein “bursting” generally refers to a process of taking one data object (e.g., an XML document) and breaking the document into multiple (possibly overlapping) parts, according to a set of bursting rules. In one embodiment, bursting rules may be used to describe a bursting configuration for a particular document type (e.g., a bursting schema for a product manual or for a collection product design drawings). The bursting rules may specify portions of a data object that a user has marked for bursting by the CMS and portions of a document that should be automatically burst by the CMS. In one embodiment, once the CMS bursts a data object, the metadata associated with a particular data object, and the individual data objects into which the document is burst, may be stored by the CMS in an independent file.

Further, the following description references embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

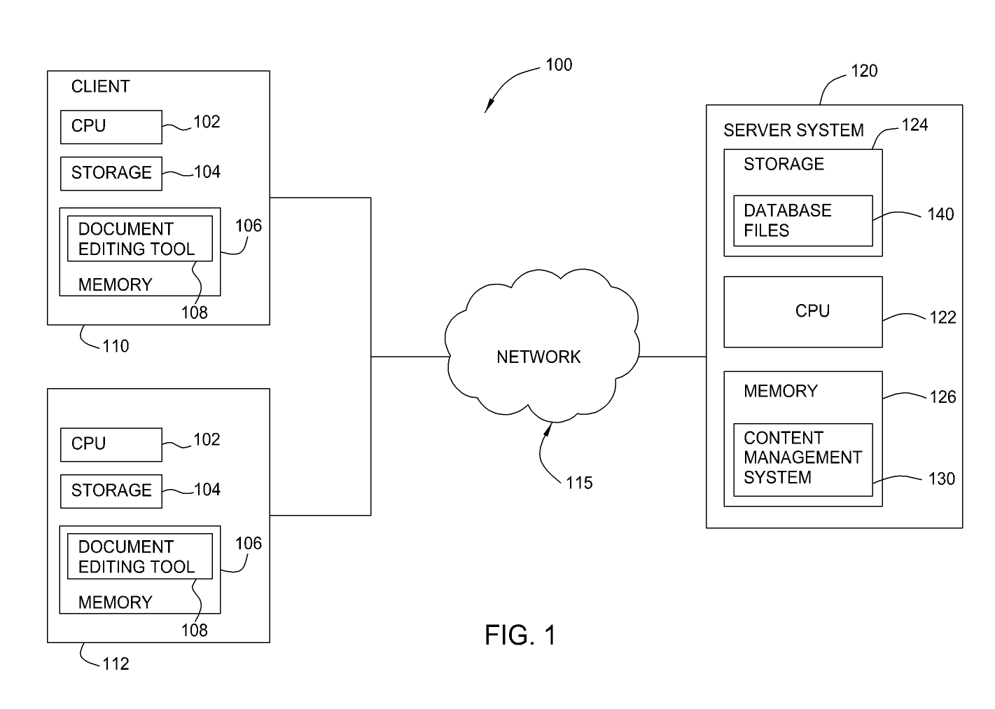

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD/DVD-ROM disks readable by a CD/DVD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks and stored on tangible storage media. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a block diagram that illustrates a client/server view of computing environment 100, according to one embodiment of the invention. As shown, computing environment 100 includes two client computer systems 110 and 112, network 115 and server system 120. The computer systems 110, 112, and 120 illustrated in environment 100 are included to be representative of existing computer systems, e.g., desktop computers, server computers laptop computers, tablet computers and the like. However, embodiments of the invention are not limited to any particular computing system, application or network architecture and may be adapted to take advantage of new computing systems as they become available. Additionally, those skilled in the art will recognize that the computer systems illustrated in FIG. 1 are simplified to highlight aspects of the present invention and that computing systems and networks typically include a variety of additional elements not shown in FIG. 1.

As shown, client computer systems 110 and 112 each include a CPU 102, storage 104, and memory 106, typically connected by a bus (not shown). CPU 102 is a programmable logic device that performs all the instructions, logic and mathematical processing performed in executing user applications (e.g., a query tool 108). Storage 104 stores application programs and data for use by client computer systems 110 and 112. Typical storage devices 104 include hard-disk drives, flash memory devices, optical media and the like. Network 115 generally represents any kind of data communications network. Accordingly, network 115 may represent both local and wide area networks, including the Internet.

Illustratively, memory 106 of client computer systems 110 and 112 includes a client application 108. In one embodiment, the editing tool 108 is software application that allows end users to access information stored in a content management system (e.g., CMS 130). The client application 108 may be configured to allow users to create, edit, and save a data object, e.g., word-processing documents, spreadsheets, database records, digital images or video data objects. However, regardless of the function or data type manipulated by client application 108, users may check-in and -out data objects from CMS 130 running on server system 120.

As shown, server system 120 also includes a CPU 122, storage 124 and memory 126. Illustratively, storage 124 includes a database 140, and memory 126 includes CMS 130. As stated, CMS 130 may provide a system for creating, modifying, arching and removing information resources from an organized repository (e.g., database files 140). Typically, CMS 130 may include tools used for publishing, format management, revision control, indexing, and search and retrieval of data objects stored by storage 124 and database 140.

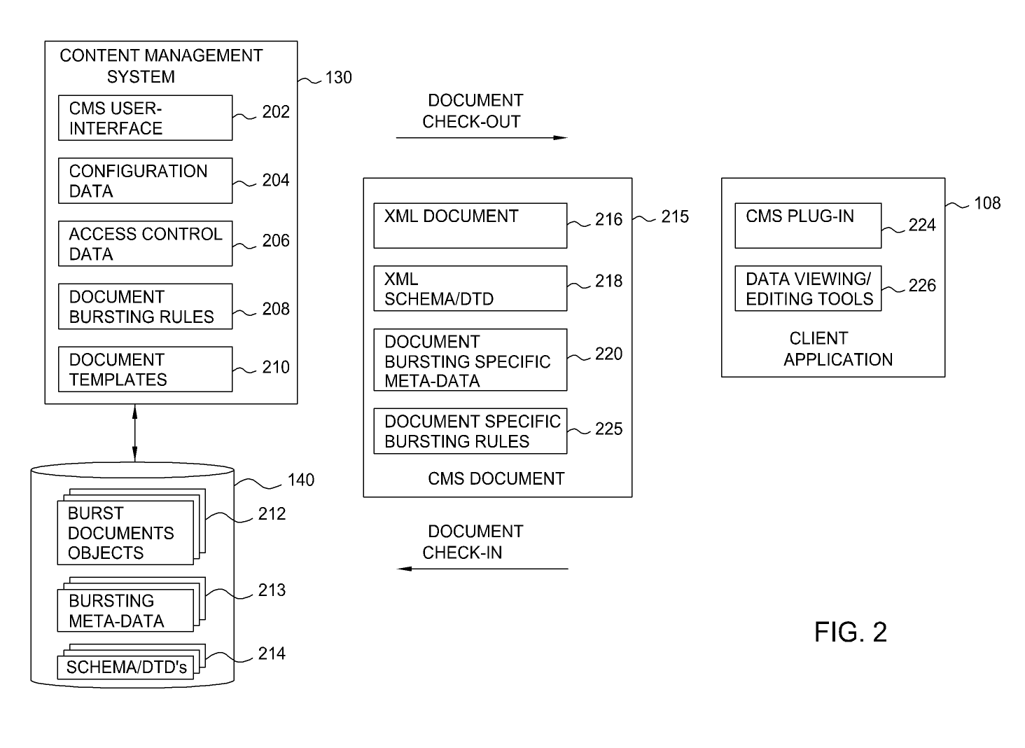

FIG. 2 is a block diagram further illustrating components of a client application 108 used to check-in and -out a document 215 from CMS 130 and database 140, according to one embodiment of the invention. As shown, CMS 130 includes a user interface 202, configuration data 204, access control data 206, document bursting rules 208 and document templates 210.

Generally, user interface 202 provides users with an interface to the functions provided by CMS 130 and content stored by database 140. Accordingly, user interface 202 may provide mechanisms for checking in/out a document from CMS 130, for specifying configuration data 204, for specifying busting rules 208 to use when processing documents generated using a particular document template 210, or for allowing CMS 130 to communicate with client application 108 through CMS plug-in 224.

Access control data 206 may specify access privileges for documents managed by CMS 130, e.g., read/write access privileges for a document based on user identify or group membership. Document templates 210 may specify default content for a particular type of document 215. For example, a document template 210 may specify the components of a product manual or for elements used for a submission to a regulatory agency. Schema/DTDs 214 provide a description of the organization of document templates 210. Generally, a DTD provides a statement of rules for an XML document specifying which elements (the markup tags) and attributes (values associated with specific tags) are allowed in a particular document. Thus, DTD 214 provides a list of the elements, attributes, comments, notes, and entities contained in the document, as well as the relationships between elements to one another.

Bursting rules 208 may specify how a particular document should be burst into multiple, reusable comments when a document (e.g., XML document 216) is checked into CMS 130. For example, using XML, bursting rules 208 may be composed as a collection of Xpath queries used for a particular document. As is known, an Xpath query may be used to specify nodes, elements, or attributes to extract from a given XML document. Thus, when a document (e.g., XML document 216) is checked-in, CMS 130 may execute a number of Xpath queries and if elements or nodes specified in the Xpath query exist within a particular document, these nodes may be retrieved and stored as a burst document object 212 in database 140. Additionally, the burst document may be modified to include an Xinclude reference used to reconstitute the document when it is subsequently reassembled and checked out.

Once burst, CMS 130 may be configured to store data regarding a given burst document as bursting metadata 213. When this document is subsequently checked out, the bursting metadata 213 may be used to assemble a group of burst objects back into a document (e.g., XML document 216) requested by a user.

Illustratively, client application 108 includes CMS plug-in 224 and data viewing and editing tools 226. Editing tools 226 provide the substantive features associated with a particular client application. For example, a word processing application may provide tools for specifying document presentation style or a CAD application may include tools for creating precise thee-dimensional digital models of real-world objects. Of course, depending on the function of client application 108, the exact features provided by viewing/editing tools 226 will vary. CMS plug-in 224 allows client application 108 to interact with CMS 130. For example, plug-in 224 may allows a user interacting with client application 108 to check-in and check-out documents from CMS 130, as well as to mark portions of a checked-out document to burst when the document is subsequently checked back in to CMS 130. Generally, when a portion of content from one document is marked as reusable, that portion of the document may be burst and stored as one of burst document objects 212 and that portion may also then be reused by multiple documents.

As shown, document 215 includes an XML document 216, an associated XML schema/DTD 218, and document specific bursting metadata 220 and bursting rules 222. XML document 216 includes the substantive data content manipulated by client application 108 and data viewing/editing tools 226. For example, the actual text of word processing document, along with markup specifying the layout and presentation of the document. XML schema/DTD 218 may be used to validate the content and structure of XML document 216.

Document specific bursting rules 222 specify which portions of the document 215 may be burst into separate objects and bursting metadata 220 may specify attributes related to each burst document object represented in the XML document 216. For example, bursting metadata 220 may specify the arrangement of burst document objects 212 in XML document 216. That is, the metadata 220 may specify where a boundary between different object occurs in XML document 216 and may also specify attributes such as access control rules to apply to different portions of the XML document 216.

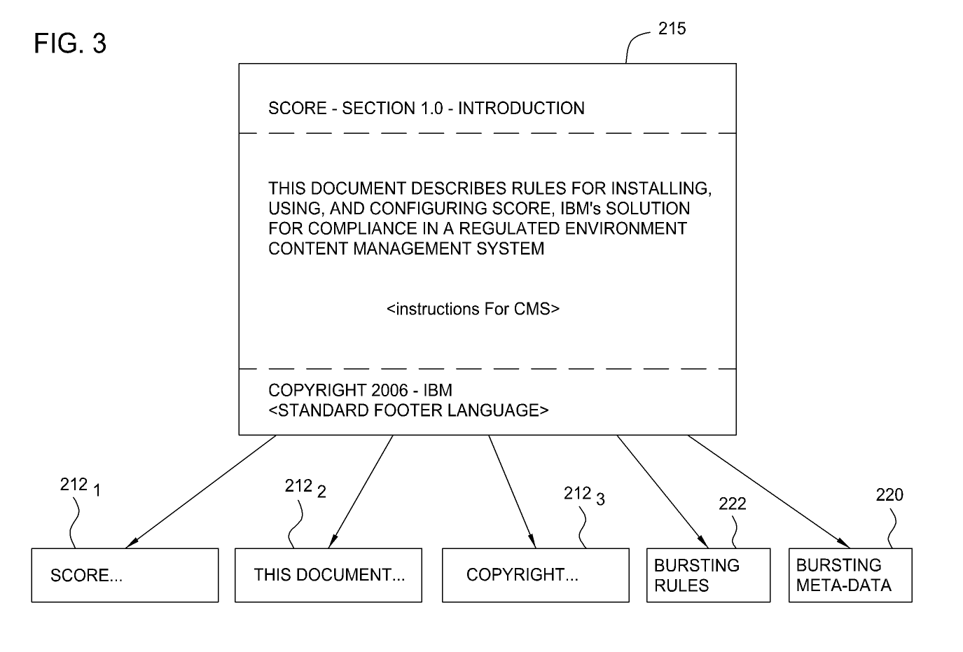

Returning to the example of a user product manual, bursting rules 222 may specify Xpath queries used to burst sections of a product manual into separate document objects 212 representing a table of contents, individual sections, legal disclaimers, and standardized headers, footers. And bursting metadata 220 may specify that a particular user is allowed to modify some sections of the product manual, but not others. FIG. 3 illustrates this example using a display of product manual 300 that may be burst into multiple reusable components by CMS 130, according to one embodiment of the invention. In this example, FIG. 3 displays a portion of a product manual (i.e., an example of XML document 216) that includes a header 305, a body 310, and a footer 315. In this example, bursting rules 222 may specify to burst product manual 300 into document objects 212₁ 212₂ and 212₃ corresponding to these three sections, when this document is checked into CMS 130. Conversely, product manual 300 may be generated from burst document objects 212₁ 212₂ and 212₃.

In one embodiment, bursting metadata 220 may specify attributes related to read/write privileges associated with product manual 300, including for examples, the boundaries between burst portions, read/write access rules for each portion, and any other information related to a burst document objects 212₁₋₃ used to generate product manual 300.

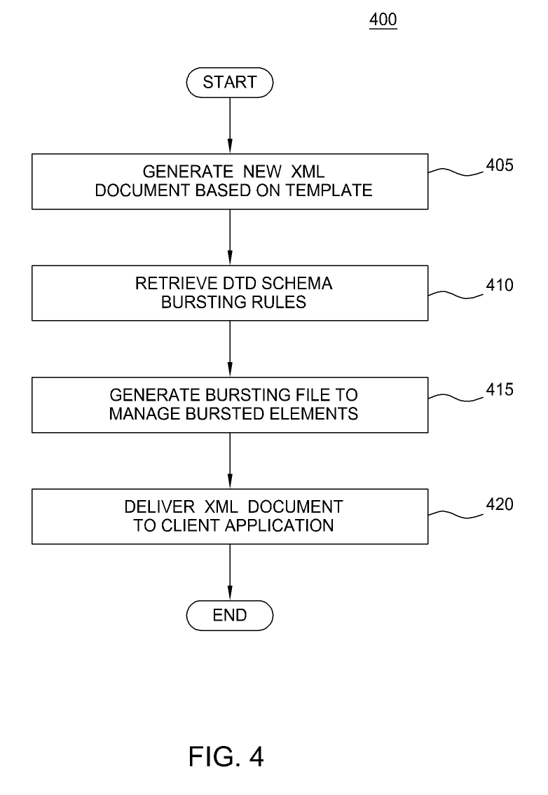

FIGS. 4-6 further illustrate methods for a CMS to create new “burstable” data objects, to burst and assemble a data object when a request to check-out an object is received, and to burst a data object when checking-in a data object into CMS 130.

First, FIG. 4 illustrates a method for creating a new data object that may include multiple reusable components, according to one embodiment of the invention. Illustratively, the method 400 describes a process for creating a new XML document managed by CMS 130. The method 400 begins at step 405 where CMS 130 generates a new XML document based on a given document template 210.

At step 410, CMS 130 may retrieve any DTDs, schemas, and/or bursting rules associated with the XML document generated at step 405. As stated, the bursting rules may specify which sections (or XML nodes, elements, tags, etc.) to burst into individual document objects 212 when the document generated at step 405 is eventually checked-in to the CMS 130. At step 415, the CMS generates a bursting data file 220 to manage any burst elements within the document generated at step 405. At step 420, the new document and all the associated files (schemas, bursting rules and bursting data) are delivered to the client (e.g., client application 108).

Additionally, the method 400 may be used to check out an XML document that had not previously been burst into multiple burst data objects 220. In such a case, instead of generating a new XML document, the CMS 130 may retrieve an existing XML document, generate a set of bursting rules and bursting metadata, and deliver this information to a client application 108.

Once received by client application 108, viewing and editing tools 226 may be used to create the substantive content of the new document. Additionally, the plug-in 224 may parse the bursting rules to identify how the new document may be burst when checked in, and to mark sections of the document as readable/writeable. For example, within the editor 224, a user may be presented with an indication of which portions of the document are managed independently by the system (i.e., portions that will be burst into burst document objects 212), allowing for any such portions to be re-used. Further, if the user marks a new portion of the document as “burstable” plug-in 224 may be configured to edit bursting metadata 220 to describe which elements the user has specified to be burst, and also edit bursting metadata 220 to describe attributes or properties related to such portions.

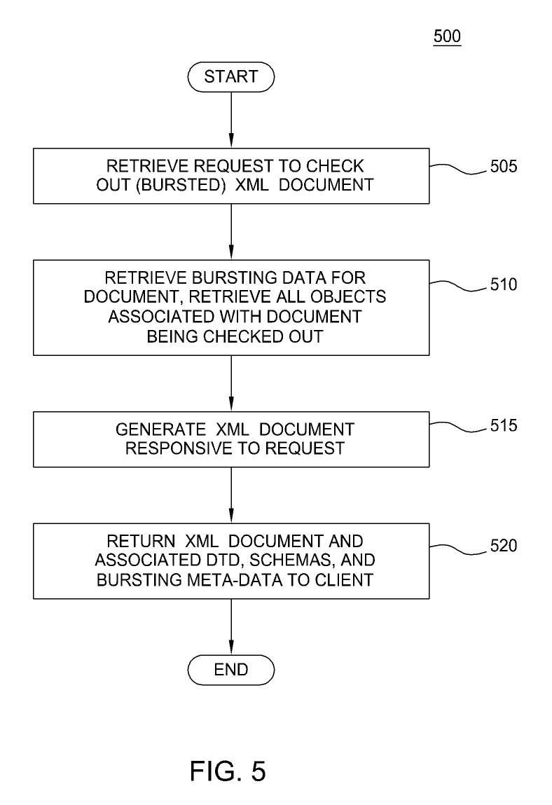

FIG. 5 illustrates a method 500 for checking-out a burst data object from CMS 130, according to one embodiment of the invention. Illustratively, the method 500 describes a process for checking-out an XML document. The method begins at step 505 where the CMS 130 receives a request to check out an XML document that has previously been burst. At step 510, the CMS 130 may parse the bursting data 220 to identify which burst data objects 212 should be included as part of the document being checked-out. Once the burst data objects 212 are identified, CMS 130 may retrieve these documents from database 140.

At step 515, the CMS 130 generates the composite XML document from the component parts. For example, in one embodiment, the burst XML document may include a set of Xinclude references to the burst data objects 212 that should be included in the XML document being checked out. In such a case, the CMS 130 de-references the Xinclude references by replacing the references with the actual burst data objects 212. Additionally, CMS 130 may generate a transient copy of the bursting metadata 220 used to record any changes related to how the document will be burst when checked-in to the CMS 130. Like the process described above regarding a new XML document, the bursting rules may also specify which portions of the document are viewable/writeable by the user while the document is checked out. When the document is checked-in, CMS 130 may parse the bursting data to determine which elements to check back in, and/or which new content to burst from the document into new document objects 222.

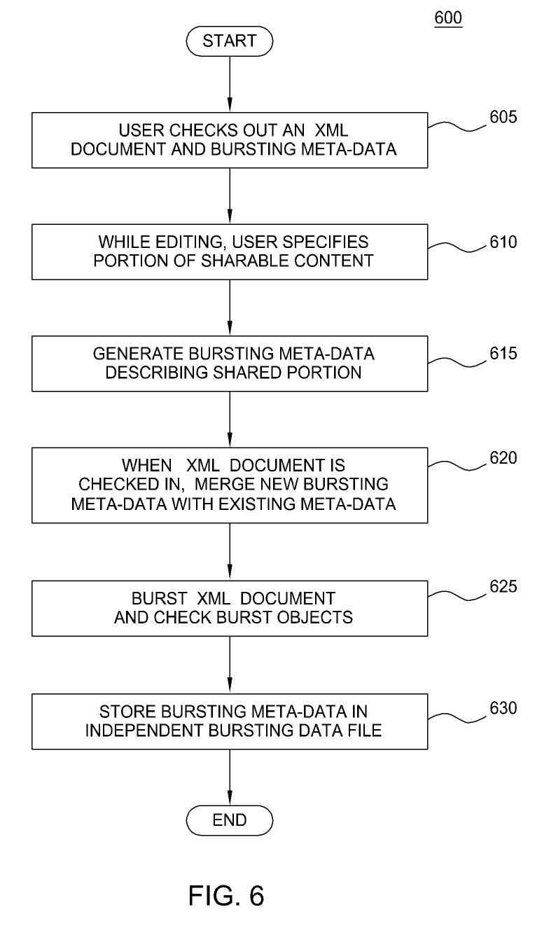

FIG. 6 illustrates a method 600 for checking in and bursting a data object managed by CMS 130, according to one embodiment of the invention. Illustratively, the method 600 describes a process for checking-in an XML document. The method 600 begins at step 605 where the user checks out an XML document and associated bursting metadata (e.g., according to one of the methods 400 or 500 illustrated in FIGS. 4 and 5).

At step 610, while the document is checked-out, a user may modify which portions of the document are “burstable” according to the bursting rules and bursting data associated with the checked-out document. For example, a user may add a new element to the XML document that is marked as “burstable” by the bursting rules or the user may modify an existing such element. As another example, the user may mark new portions of the document as “burstable,” in which case, the plug-in 224 may update the bursting metadata 220 delivered to the client application 108 when the document was checked-out (e.g., as part of step 515 of the method 500). At step 615, plug-in 224 updates the bursting data associated with the XML document whenever the user makes a change to a “burstable” portion of the document or adds new elements that may be burst, according to the bursting rules associated with the checked-out document.

At step 620, the user may check-in the XML document. In one embodiment, the client application 108 transmits the XML documents (including any modifications) and the bursting data associated with the document back to the CMS 130. Once received, at step 625, the CMS 130 may be configured to parse the bursting data received from the client application 108 and identify which new elements need to be burst into independent data objects 212. The CMS 130 may then use the bursting rules (e.g., Xpath queries to break out the elements in the XML document being checked-in into their own burst data objects 212). Additionally, each burst element may be replaced with an XInclude tag in the original XML document. At step 630, the bursting data associated with the document being checked may be updated to reflect any new burst elements. In other words, each time a document is checked-in, the bursting metadata 220 may be updated to reflect how the document is currently burst by the CMS 130.

Advantageously, by storing the bursting metadata in a separate data file, the bursting metadata can be described independently of a customer's specific DTDs or schemas. Thus, the CMS can store and manage data objects without disrupting existing XML grammars. Further, the bursting metadata file may be managed by the CMS. By allowing the associated file to be managed by the CMS, a client application may access the bursting metadata through a standard API instead of having to know the specific implementation details when parsing the XML at the client (as is the case today).

While the foregoing is directed to embodiments of the present invention, other and further embodiments of the invention may be devised without departing from the basic scope thereof, and the scope thereof is determined by the claims that follow.

What is claimed is:

1. A method of managing content in a content management system (CMS), comprising:
identifying a set of bursting rules associated with a specified type of data object, wherein the bursting rules specify portions of the data object that may be stored independently by the CMS;
receiving a data object of the specified type;
parsing the received data object to identify portions of the data object that may be stored independently by the CMS, based on the bursting rules;
bursting the parsed data object into a collection of burst data objects; and
generating a bursting metadata file describing attributes of the data object.

2. The method of claim 1, wherein the data object comprises an XML document, and wherein the bursting rules specify which nodes of the XML document to burst into individual burst data objects.

3. The method of claim 2, wherein the bursting rules are specified as a collection of XPath queries.

4. The method of claim 2, wherein a node of the XML document is replaced with an Xinclude statement referencing an associated burst data object.

5. The method of claim 2, wherein the XML document is used to describe one of a word processing documents spreadsheet, database record, digital image, or a digital video sequence.

6. The method of claim 1, wherein the attributes of the data object include read/write access privileges for one of the collection of burst data objects.

7. The method of claim 1, further comprising,
receiving a request to check-out the data object;
retrieving the collection of burst data objects and the bursting metadata file describing attributes of the data object;
reconstituting the data object from the collection of burst data objects; and
transmitting the data object and the bursting metadata to a requesting application.

8. The method of claim 7, wherein the data object comprises an XML document.

9. The method of claim 7, wherein the requesting application allows a user to specify additional portions of the data object to burst when creating the collection of burst data objects.

10. A computer-readable medium containing a program which, when executed, performs an operation for managing content in a content management system (CMS), comprising:
identifying a set of bursting rules associated with a specified type of data object, wherein the bursting rules specify portions of the data object that may be stored independently by the CMS;
receiving a data object of the specified type;
parsing the received data object to identify portions of the data object that may be stored independently by the CMS, based on the bursting rules;
bursting the parsed data object into a collection of burst data objects; and
generating a bursting metadata file describing attributes of the data object.

11. The computer-readable medium of claim 10, wherein the data object comprises an XML document, and wherein the bursting rules specify which nodes of the XML document to burst into individual burst data objects.

12. The computer-readable medium of claim 11, wherein the bursting rules are specified as a collection of XPath queries.

13. The computer-readable medium of claim 11, wherein a node of the XML document is replaced with an Xinclude statement referencing an associated burst data object.

14. The computer-readable medium of claim 11, wherein the XML document is used to describe one of a word processing documents spreadsheet, database record, digital image, or a digital video sequence.

15. The computer-readable medium of claim 10, wherein the attributes of the data object include read/write access privileges for one of the collection of burst data objects.

16. The computer-readable medium of claim 10, further comprising,
receiving a request to check-out the data object;
retrieving the collection of burst data objects and the bursting metadata file describing attributes of the data object;
reconstituting the data object from the collection of burst data objects; and
transmitting the data object and the bursting metadata to a requesting application.

17. The computer-readable medium of claim 16, wherein the data object comprises an XML document.

18. The computer-readable medium of claim 16, wherein the requesting application allows a user to specify additional portions of the data object to burst when creating the collection of burst data objects.

19. A system, comprising:
a processor; and
a memory containing a content management system (CMS) configured to:
identify a set of bursting rules associated with a specified type of data object, wherein the bursting rules specify portions of the data object that may be stored independently by the CMS;
receive a data object of the specified type;
parse the received data object to identify portions of the data object that may be stored independently by the CMS, based on the bursting rules;
burst the parsed data object into a collection of burst data objects; and
generate a bursting metadata file describing attributes of the data object.

20. The system of claim 19, wherein the CMS is further configured to:
receive a request to check-out the data object;
retrieve the collection of burst data objects and the bursting metadata file describing attributes of the data object;
reconstitute the data object from the collection of burst data objects; and
transmit the data object and the bursting metadata to a requesting application.
